(19) United States
(12) Patent Application Publication
(10) Pub. No.: US 2002/0188632 A1
(43) Pub. Date: Dec. 12, 2002

(54) Table editor for web pages

(76) Inventor: Ming-Shing Su, Taipei (TW)

Correspondence Address: POWELL, GOLDSTEIN, FRAZER & MURPHY LLP, P.O. BOX 97223, WASHINGTON, DC, 20090-7223, US

(21) Appl. No.: 09/874,529

(22) Filed: Jun. 6, 2001

(51) Int. Cl. G06F 15/00

(52) U.S. Cl. 707/513; 707/506

(57) ABSTRACT

A method and apparatus for allowing a user to edit a table in a Web page is provided. The method comprises displaying the table and several display elements on a display device. An indication is received, which user wants to add one of the display elements or modify a layout of the table to the table. A cell structure is added or changed for the display element to several table structures corresponded to the table on the display device. In response to the indication is generated to change a display of the table and several HTML (HyperText Markup Language) or XML codes that substantially reflect the table in accordance with the table structures on the display device.

### BACKGROUND OF THE INVENTION

1. Field of the Invention

The invention relates to a table editor for multi-media processing, and more particularly to a table editor in any homepage editor, which allows users to design tables of homepages in a user-friendly manner.

2. Description of the Prior Art

The past several years have seen an explosive growth of the World Wide Web (“the Web”). The Web is built around a network of “server” computers, which exchange requests and data with each other using the hypertext transfer protocol (“http”). A human designer designs the layout of a Web page, which is the specified using HTML (“HyperText Markup Language”). Several versions of HTML are currently in existence. Examples include HTML versions 2.0 and 3.0, as specified by the WWW Consortium of MIT. Netscape Communications Corp. has specified additional HTML features that extend HTML forms and tables.

The HTML to describe a Web page is often created by hand by a human being. If the design of the page changes, the corresponding HTML must be rewritten, which is an exacting process. Although several conventional HTML editors exist, these editors only allow the user to specify certain elements of a page and frequently still require the user to physically enter HTML code. Conventional HTML editors allow the user to specify the page content and general layout, but do not provide the user with “What you see is what you get” capability. Thus, the pages generated by conventional HTML editors look different when viewed by different browsers.

Conventionally, users may utilize a table of text processing and spread sheet processing to specify the page content and layout. In text processing and spread sheet processing, there often arise occasions in which it is necessary to insert or delete rows or columns in order to edit an existing table. However, general table editors in conventional HTML editors can not provide a user-friendly table creating system that is simple and definite in the designation of a table. Furthermore, it is also difficult for users to edit various types of objects or elements in the table by the conventional HTML editors.

### SUMMARY OF THE INVENTION

It is an object of the present invention to provide users a method and apparatus for editing a table. Users may add the display elements of different types, such video, flash, into the table that can be built in any Web page.

It is another object of the present invention to provide a method for user-friendly editing a table of a Web page. User can flexibly modify the table by using dragging and dropping of a cursor.

In the present invention, a method and apparatus for allowing a user to edit a table in a Web page is provided. The method comprises displaying the table and several display elements on a display device. An indication is received, which user wants to add one of the display elements or modify a layout of the table to the table. A cell structure is added or changed for the display element to several table structures corresponded to the table on the display device. In response to the indication is generated to change a display of the table and several HTML (HyperText Markup Language) or XML codes that substantially reflect the table in accordance with the table structures on the display device.

### BRIEF DESCRIPTION OF THE DRAWINGS

A better understanding of the invention may be derived by reading the following detailed description with reference to the accompanying drawing wherein

FIG. 1 is a block diagram of a computer system in accordance with a preferred embodiment of the present invention;

FIG. 2 is a schematic diagram showing representative types of a table object in accordance with a preferred embodiment of the present invention;

FIGS. 3A-3B are schematic diagrams illustrating editing a table in accordance with the present invention;

FIGS. 4A-4C are schematic diagrams illustrating adding existentially display elements into the cells of the table in accordance with the present invention;

FIGS. 5A-5B are schematic diagrams illustrating adding a new-created display element into the cell of the table in accordance with the present invention;

FIGS. 6A-6B are schematic diagrams illustrating a table-editing window in detail in accordance with the present invention;

FIGS. 7A-7B are schematic diagrams illustrating one of the functions in the table-editing window in accordance with the present invention;

FIGS. 8A-8B are schematic diagrams illustrating the division function in the table-editing window in accordance with the present invention; and

FIGS. 9A-9B are schematic diagrams illustrating a mergence function in the table-editing window in accordance with the present invention.

### DESCRIPTION OF THE PREFERRED EMBODIMENT

While the invention is described in terms of a single preferred embodiment, those skilled in the art will recognize that many modules described below can be altered and that species and types as well as other substitutions can be freely made without departing from the spirit and scope of the invention.

Furthermore, there is shown a representative portion of a system of the present invention in enlarged, the drawings are not necessarily to scale, as the modules are shown for clarify of illustration and should not be interpreted in a limiting sense.

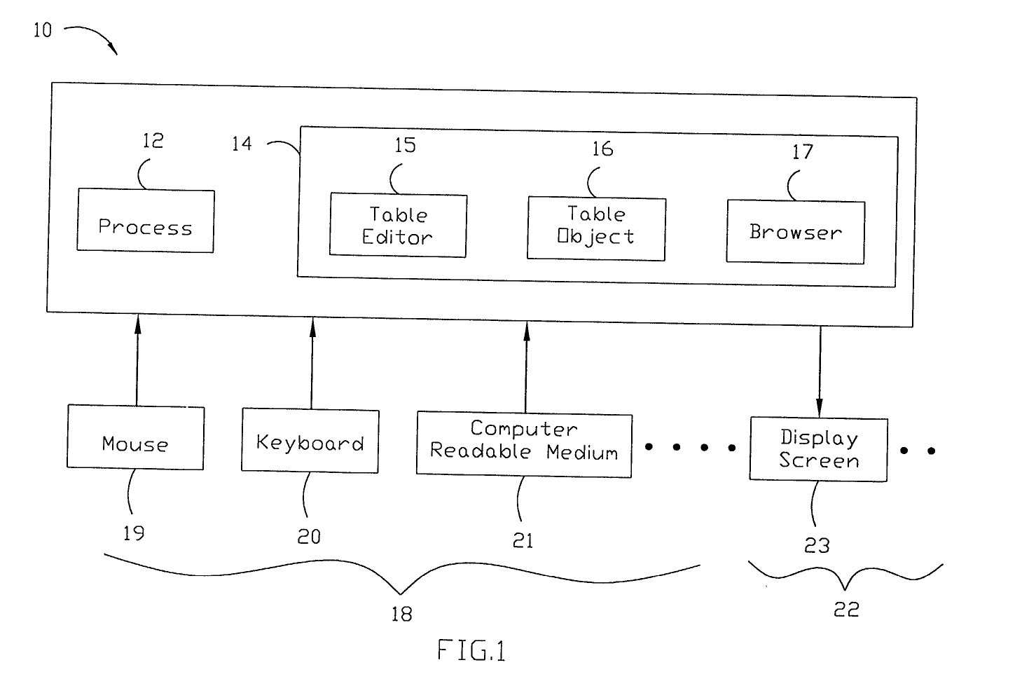

FIG. 1 is a block diagram of a computer system 10 in accordance with a preferred embodiment of the present invention. The computer system 10 includes a CPU 12, a memory 14, multitudes of input devices 18 and output devices 22. The input device 18 may be, for example, a mouse 19, a keyboard 20, or a computer readable medium 21 such as a floppy disk driver or CD-ROM reader. The output device 22 can be a display screen 23. The memory 14 includes a table editor software 15, multitude of objects 16, and a browser 17. A person of ordinary skill in the art will understand that the memory 14 also contains additional information, such as application programs, operating systems, data, etc. It also will be understood that the computer system 10 can also include numerous elements not shown in the figure for the sake of clarity, such as disk drivers, network connections, additional memory, additional CPUs, LANs, internet connections, input/output lines, etc.

Furthermore, in the following discussion, the steps of methods and steps discussed preferably are performed by the process 12 executing instructions stored in memory, such as instructions of the table editor software 15. The table editor software 15 can be initially loaded into memory from the computer readable medium 21.

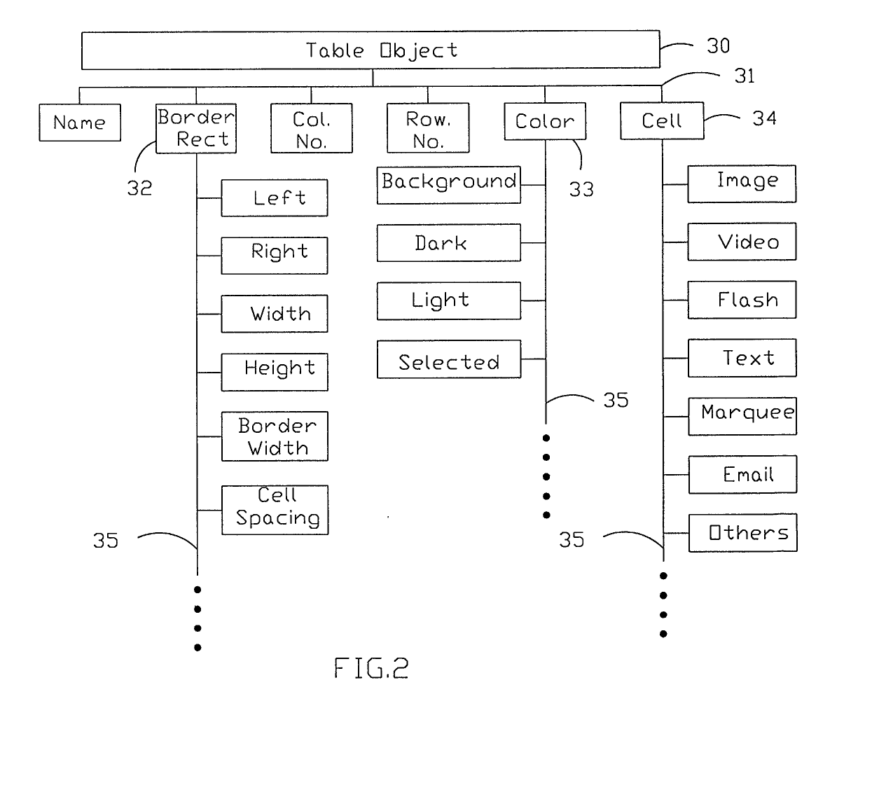

FIG. 2 is a schematic diagram showing representative types a table object 30 can have. At a top level, the table object 30 can have a plurality of basic object types as shown on the first level 31 of the structure. By way of example, these types may include: name, bound receipt, column number, row number, color, cell, etc. The table component in turn can have one of many different additional or derived data types. In the preferred embodiment shown in the second level 35 in FIG. 2, a border rectangle 32 can take the form of left, right, width, height, border width, cell spacing, or any other type of component object. A color 33 can take the form of background, dark, light, or any other type of selected object. A cell 34 can take the form of image, video, flash, text, marquee, e-mail, or any other type of multi-media object. These additional objects or data types allow the application developer great flexibility in choosing what type of data can be contained in the cell 34.

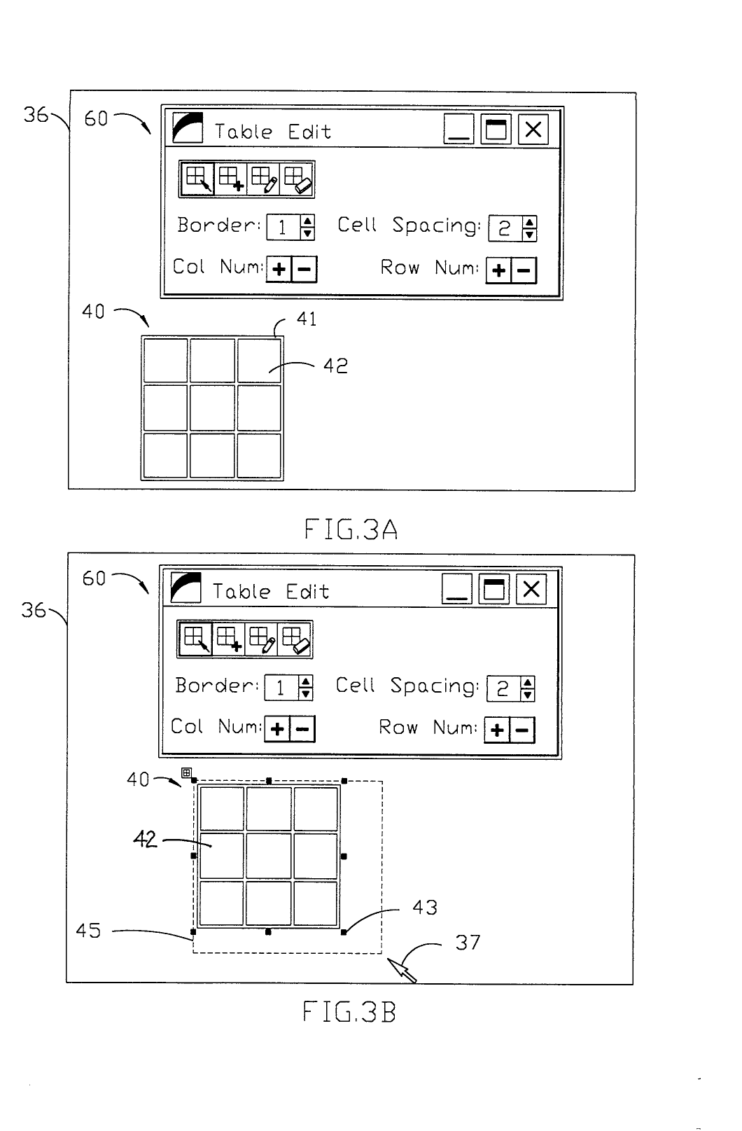

FIG. 3A is a schematic diagram illustrating editing a table in accordance with the present invention. A new table 40 is created in an edited window 36. The edited window 36 may be created in any editor Web page software. There may be several bars, buttons, or any type icons of editing function included in the edited window 36 and not shown in FIG. 3A. A table-editing window 60 is also shown in the edited window 36. The table-editing window 60 may be hidden or displayed by a hot key (not shown) in the edit window 36. The table-editing window 60 of the present invention can be built in any editor software of Web page. In the embodiment, the table-editing window 60 is built in a multi-media editor as described in U.S. application Ser. No. 09/679,242 of Ming-Shing Su et al., filed concurrently herewith, and entitled “Multimedia web-page editor”. The table 40 includes a border 41 and a multitude of cells 42. The border 41 also includes a multitude of lines among cells 42 and layout of the table 40.

Shown in FIG. 3B, when the table editor of the present invention is built in any editor of Web page software, users can directly design the size of the table 40 with an input device. For example, users enlarge diagonal the table 40 to any a boundary 45 by dragging and dropping a mark 43 with a cursor 37. All cells 42 in the table 40 are also enlarged diagonally at the same time. Users can instinctively adjust the size of the table 40 without knowing the exact numbers of the size. An advantage of above-mentioned is to provide users an instinctive and user-friendly tool for editing the table 40 instead of a quantitative one that users need to input numbers.

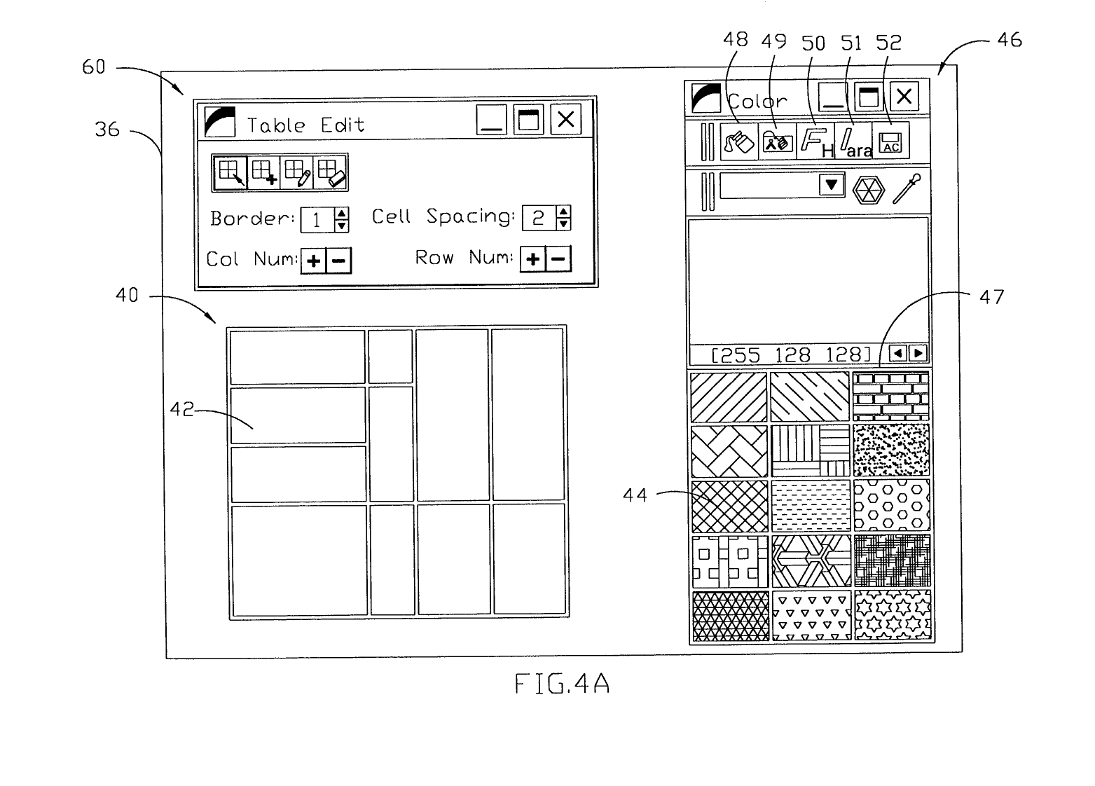

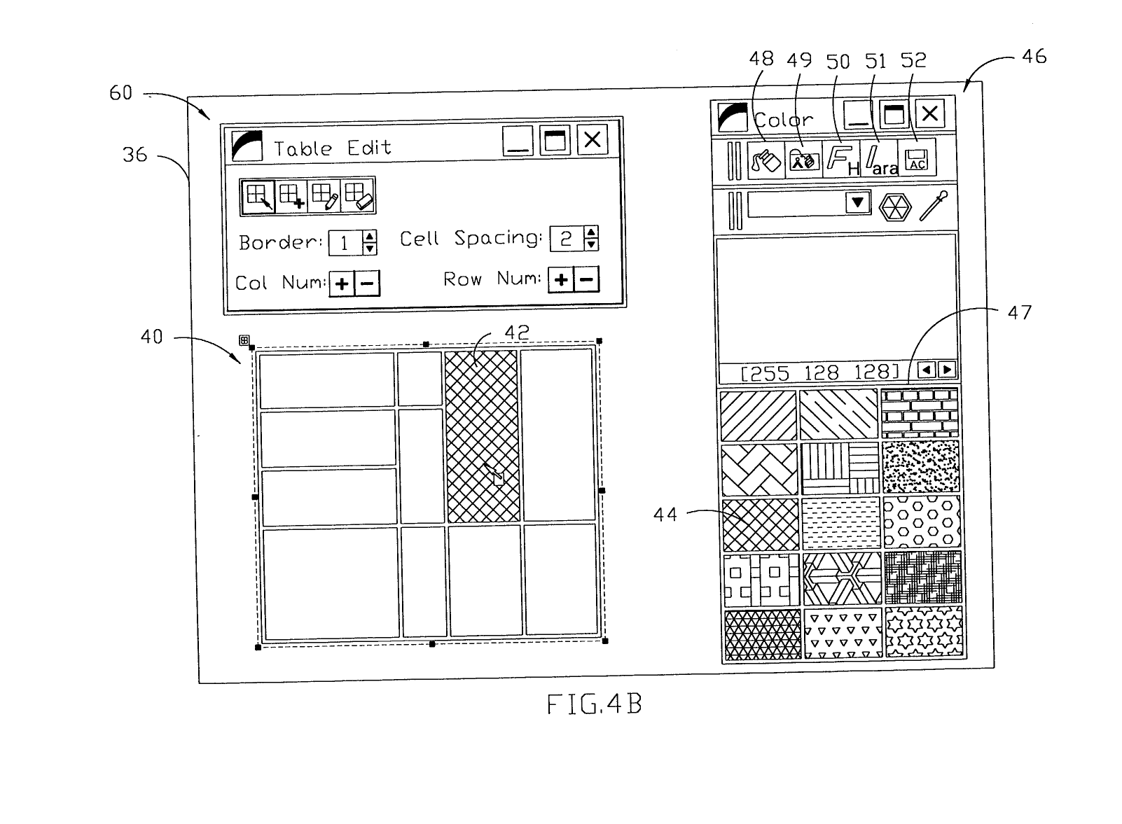

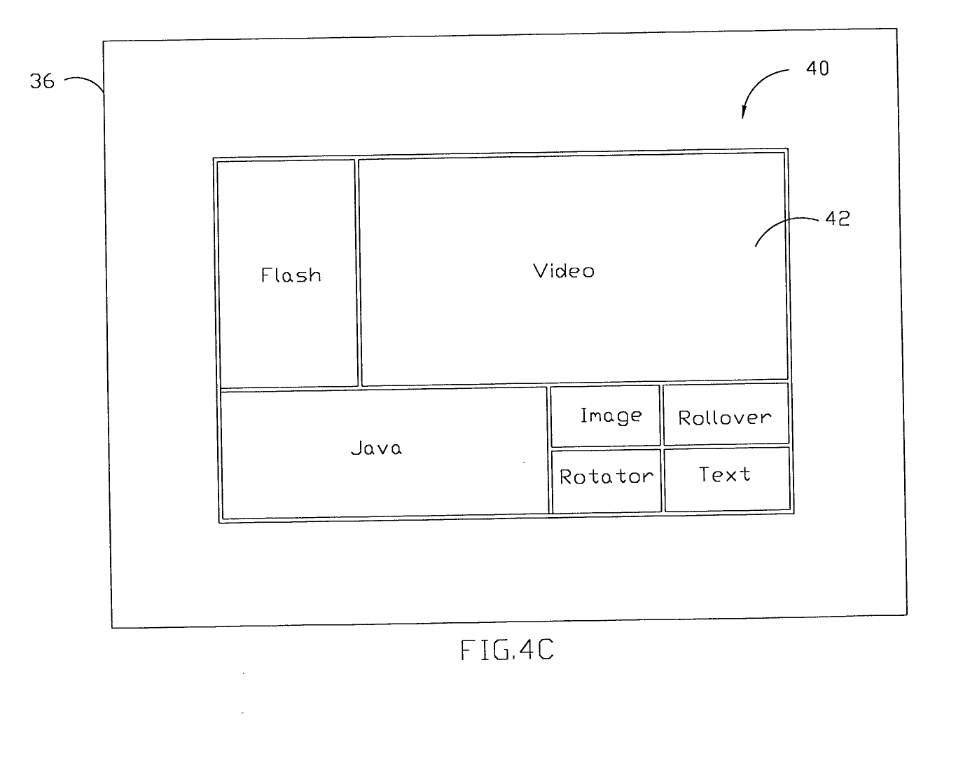

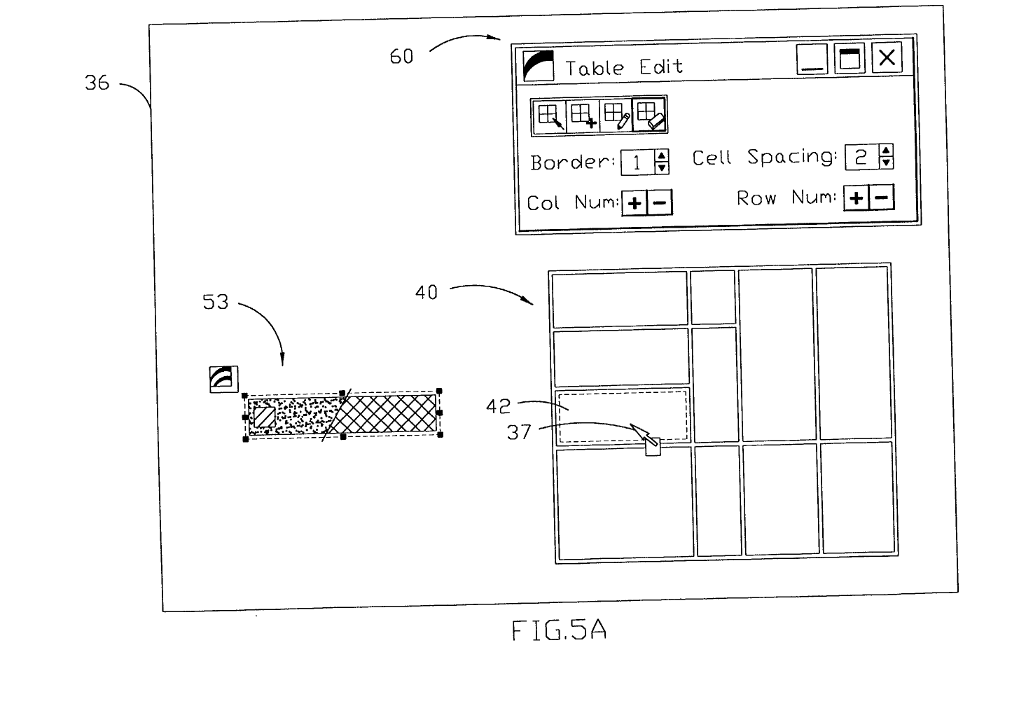

FIG. 4A is a schematic diagram illustrating adding a display element into the cell 42 of the table 40 in accordance with the present invention. The window of a multimedia bank 46 may be popped out by a corresponding hot button. The window of the multimedia bank 46 displays several hot buttons: a “color plate” button 48, an “image” button 49, a “flash” button 50, a “Java” button 51, and a “video” button 52, etc. Users may push each hot button for showing display elements in a display zone 47. For example, users push the “color plate” button 48 and several color elements 44 are shown in the display zone 47, shown in FIG. 4A. Users can directly drag a designed color element in the display zone 47 by the cursor 37 and drop it into the cell 42 of the table 40, shown in FIG. 4B. Alternatively, the color element 44 in the cell 42 also can be removed by dragging and dropping of the cursor 37. This feature makes it easy for users to select specific display elements for individual cell 42 of the table 40. It will be understood by persons of ordinary skill in the art that users also can any a select display element applied to the whole table 40. The added display elements in the cell 42 or in the whole table 40 automatically create certain table objects in memory for the table 40. These automatically created table objects reflect links between the table of the site.

Furthermore, all of the display elements with various types can be added into the cell 42 of the table 40, such as a flash object, a video object, etc. All of display elements selected from the hot buttons may be added into the cell 42. It will be understood by persons of ordinary skill in the art that other hot buttons different from the above-mentioned also can be defined by users, not limited within the range of the above-mentioned. Shown in FIG. 4C, each cell 42 in the table 40 may contain a specified display element with different type.

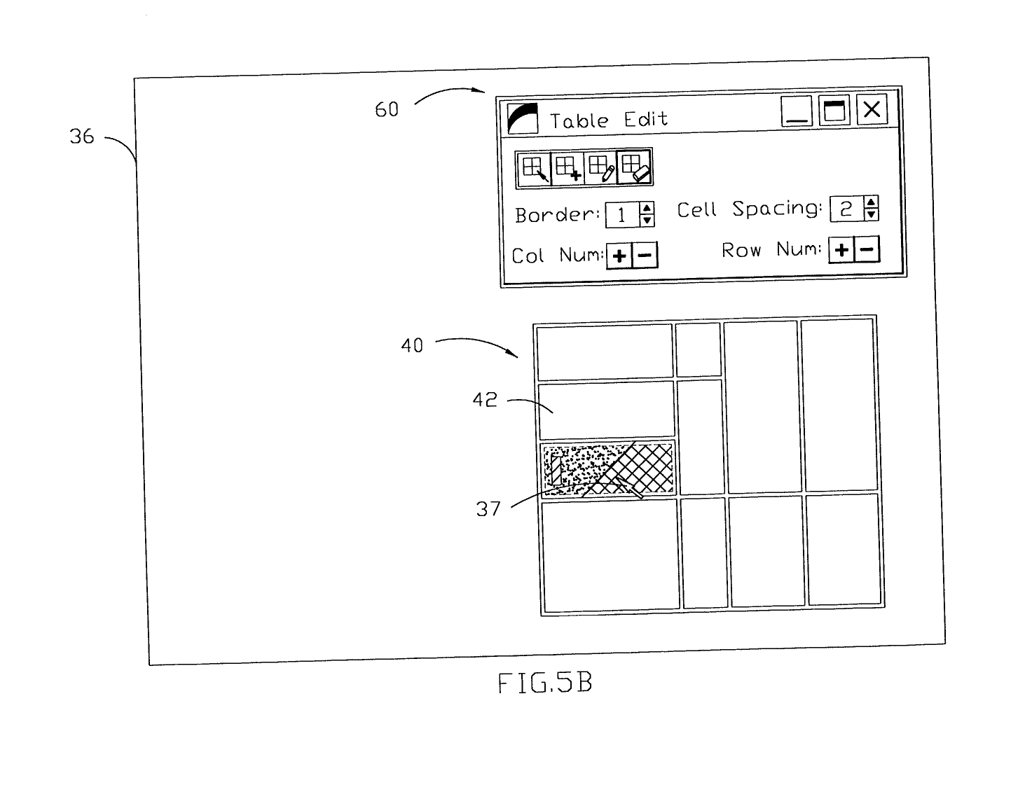

Users also can easily create display elements on the edited window 36 and then add them to the cell 42 of the table 40. Shown in FIG. 5A, users may first design a created display element 53 on the edited window 36 and then add it to the cell 42 by dragging and dropping of the cursor 37 into the table 40 region. Shown in FIG. 5B, the created display element 53 is added to the cell structure of the cell 42. Of course, users may easily remove the created display element 53 by dragging and dropping of the cursor 37 out of the table 40 region.

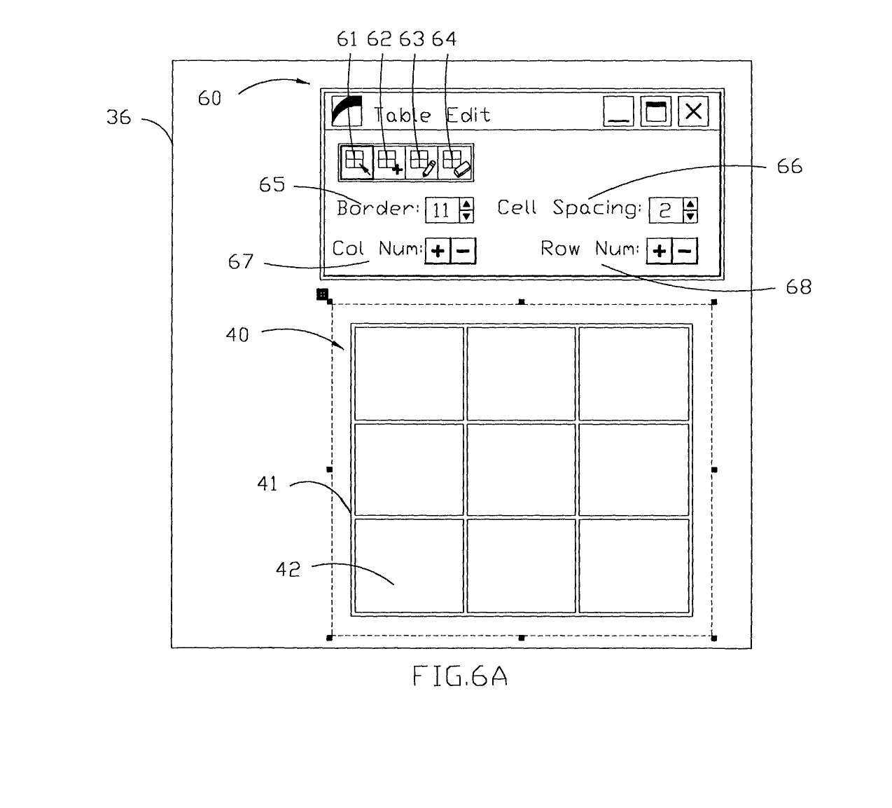

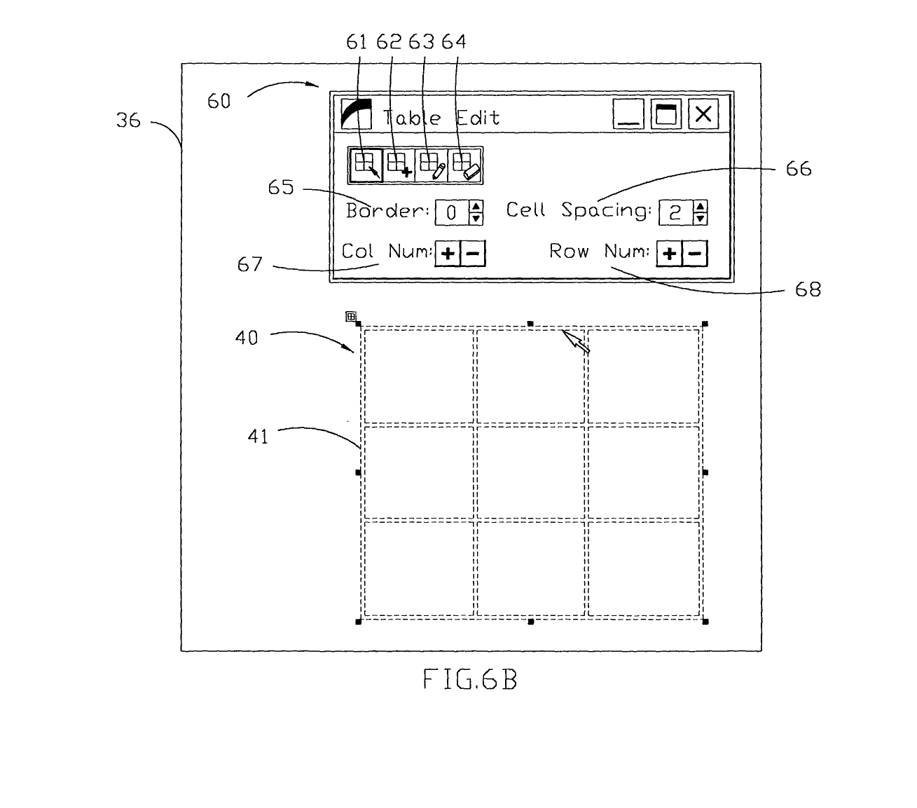

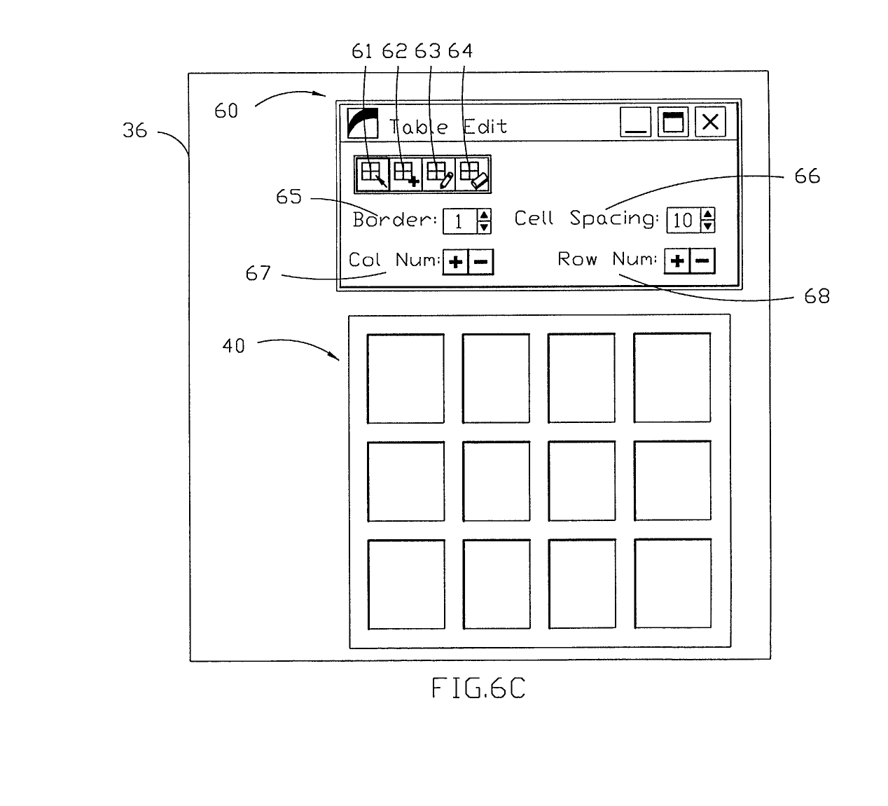

The table-editing window 60 is described in detail below. Shown in FIG. 6A, there are several hot buttons for editing tables: a “border width” button 61, a “cell size” button 62, a “cell division” button 63, and a “cell mergence” button 64. Users can adjust the display characters of the table 40 with these hot buttons. Furthermore, users also can adjust the table 40 with several combo boxes, such as a border box 65, a cell spacing box 66, a column number box 67, and a row number box 68, etc. For example, users set a border width for the table 40 and a cell space for the cell 42 with the border box 65 and the cell spacing box 66. The widths of the border 41 and the space width of the cell 42 are dynamically displayed according to the settings of the border box 65 and cell spacing box 66. In FIG. 6A, the width of the border 41 is 11 and the space width of the cell is 2. In FIG. 6B, the width of the border 41 is zero and the border 41 is displayed with marquee. In FIG. 6C, the width of the border 41 is 1 and the space width of the cell 42 is 10. Furthermore, the number of row or column in the table 40 can be set with the row number box 67 or the column number box 68. In FIG. 6C, the numbers of the row and column are increased to 4.

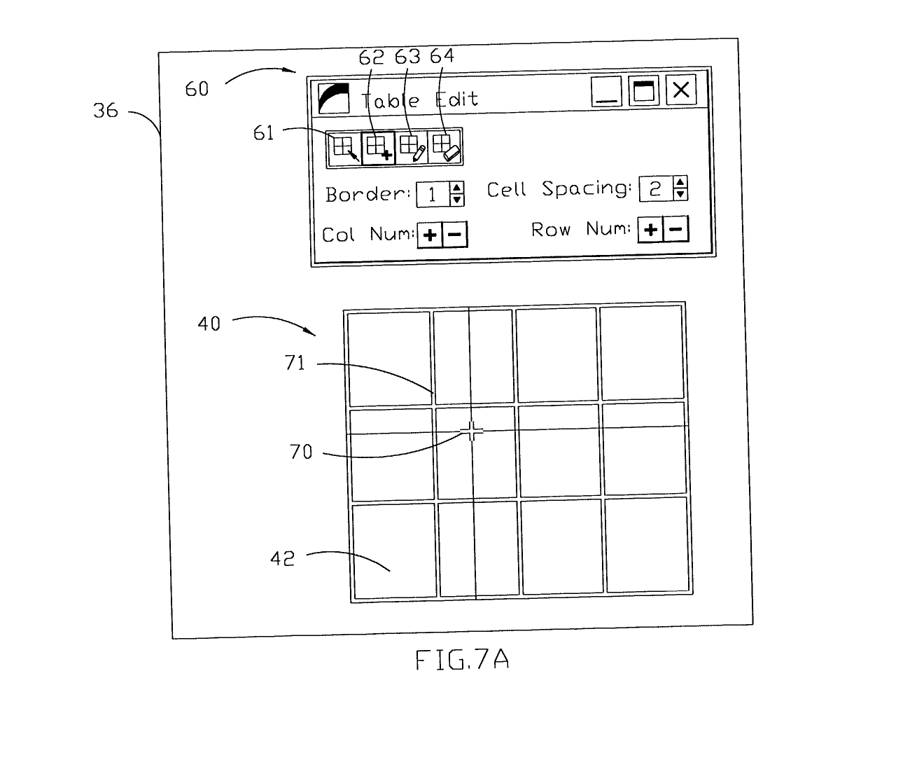

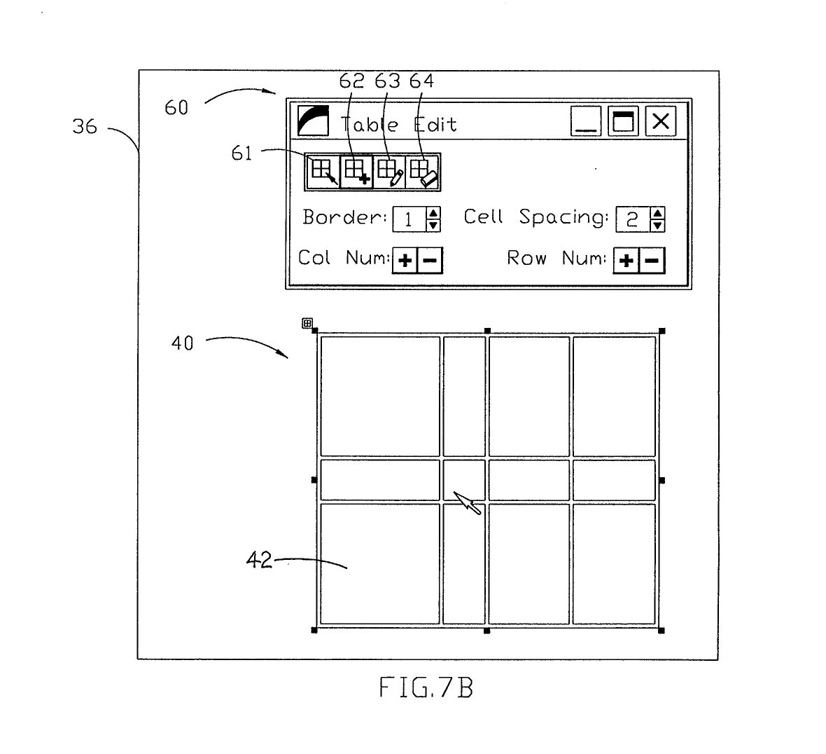

Depicted in FIG. 7A, horizontal and vertical dividers are shown in the table 40 when users push the “cell size” button 62. A cross 70 combines the horizontal divider with the vertical divider. Users can select and move the cross 70 by the cursor 37. For example, user can select an intersection 71 with the cross 70 and move it by dragging and dropping of the cursor 37. The horizontal and vertical dividers are moved following the cross 70. Furthermore, the sizes of the cells 40 around two dividers are varied according to the movement of intersection 71, shown in FIG. 7B.

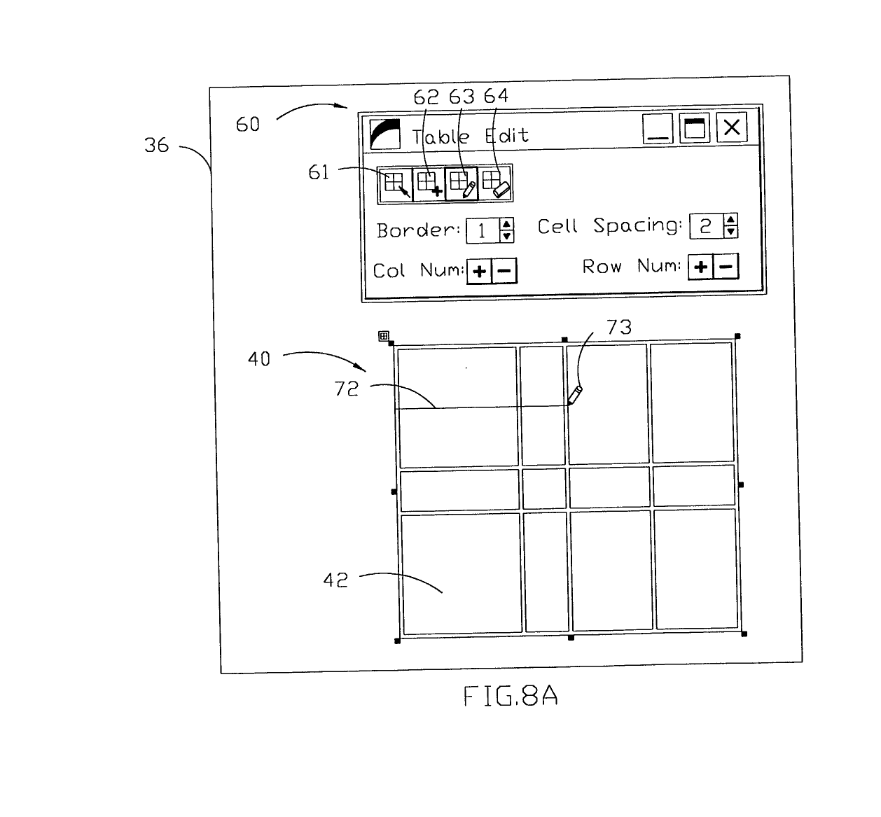

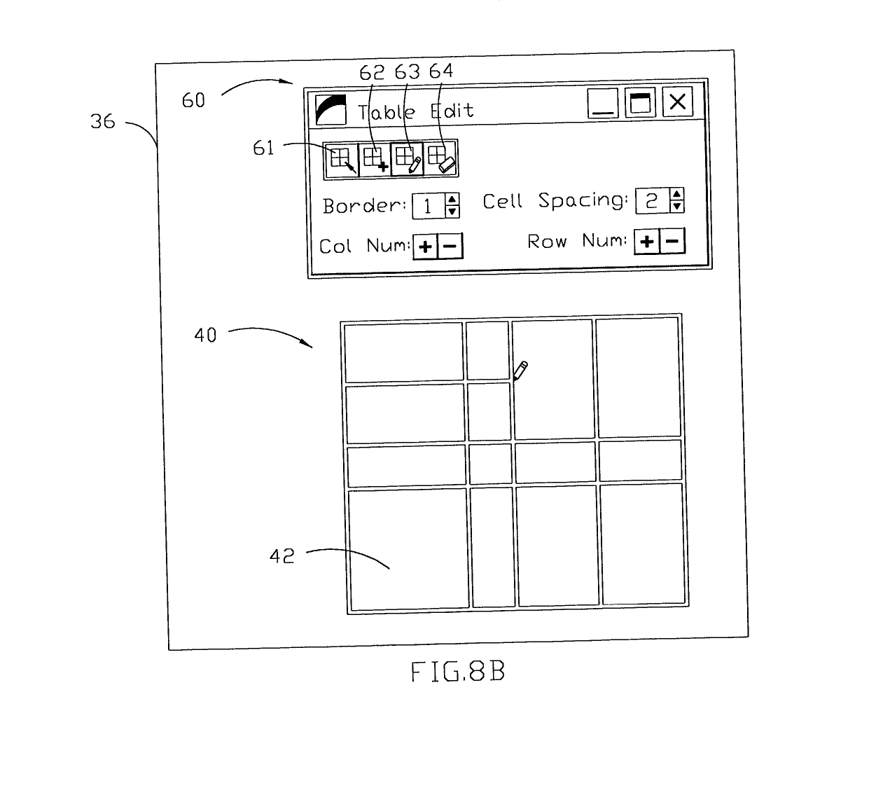

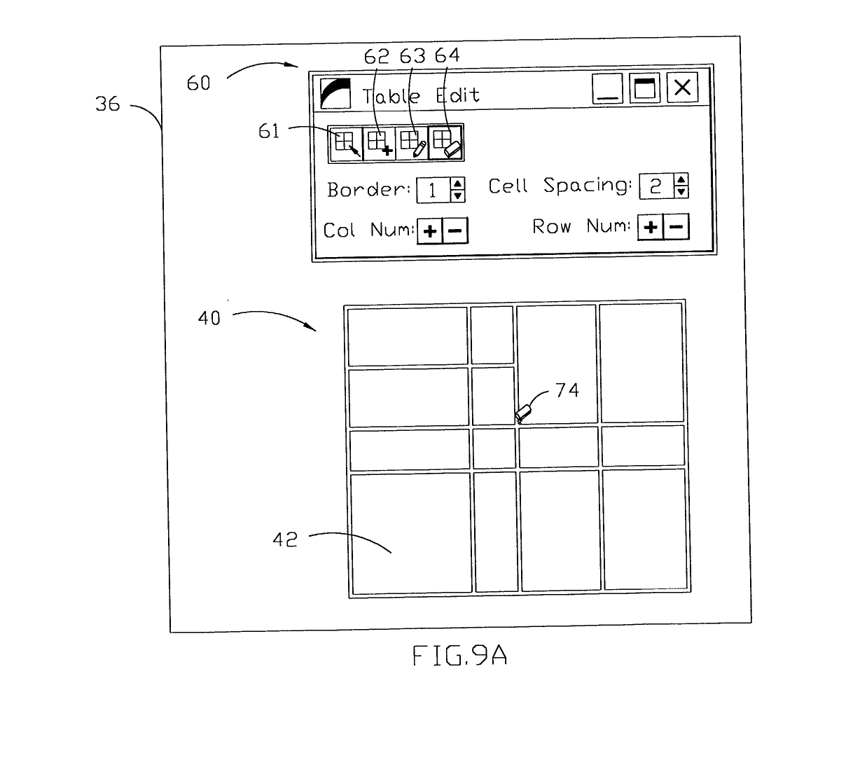

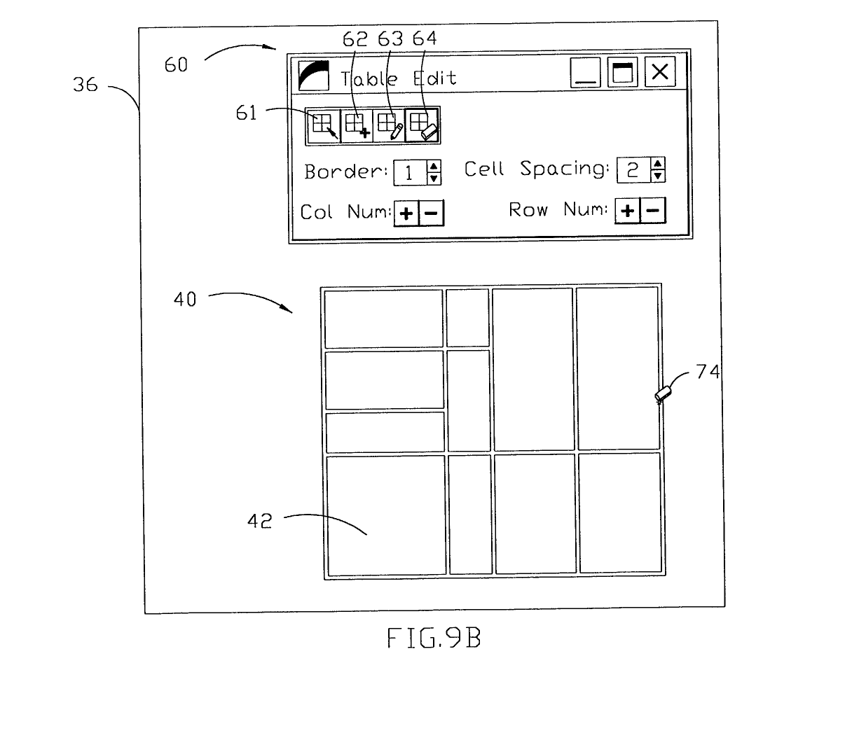

The “cell division” button 63 may provide a painting pen 73 for editing the table 40, shown in FIG. 8A. Users can move the painting pen 73 to draw a line 72 for dividing the cells 42 in the table 40. Shown in FIG. 8B, users easily divide the cell 42 by the line 72. Alternatively, the “cell mergence” button 64 provides an eraser 74 for editing the table 40, shown in FIG. 9A. User may have the eraser 74 by pushing the “cell mergence” button 64 and directly erase the boundaries of the cells 42 thereby, shown in FIG. 9B. Specifically, all designed display elements in the table or layout of the table can be previewed the effects on a Web page shown on the output device. Users preview the table with a specifically hot button (not shown). The HTML or XML (extensible Markup Language)code for the table is also automatically generated for storage.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of allowing a user to edit a table of a Web page performed by a data processing system, said method comprising:
displaying said table and a plurality of display elements, said table having a plurality of cells;
receiving a first indication that said user wants to add at least one of said display elements to one of said cells of said table;
adding a cell structure for said display element to a plurality of table structures, said table structures corresponding to said table on said display device; and
generating in response to said first indication to change a display of said table and a plurality of HTML (HyperText Markup Language) codes that substantially reflect said table in accordance with said table structures.

2. The method according to claim 1 further comprising:
receiving a second indication that said user wants to modify a layout of said table in accordance with said display elements;
changing said table structures according to said modified layout; and
generating in response to said second indication to renew said display of said table and changing said HTML codes.

3. The method according to claim 2, wherein said layout of said table comprises a plurality of colors for said cells and said table.

4. The method according to claim 2, wherein said modifying said layout of table comprises changing a plurality of sizes of said cells.

5. The method according to claim 2, wherein said modifying said layout of table comprises changing a size of said table.

6. The method according to claim 1 further comprising generating a plurality of XML (extensible Markup Language) codes.

7. The method according to claim 1, wherein said first indication and said second indication are implemented by dragging and dropping of a cursor device.

8. The method according to claim 1, wherein said display elements comprise a plurality of object types selected from the groups of text, image, video, flash, and Java applet.

9. Apparatus allowing a user to edit a table of a Web page, said apparatus comprising:
a portion configured to display said table and a plurality of display elements on a display device, said table having a plurality of cells;
a portion configured to receive a first indication that said user wants to add at least one of said display elements to one of said cells of said table;
a portion configured to add a cell structure for said display element to a plurality of table structures, said table structures corresponding to said table on said display device; and
a portion configured to generate in response to said first indication to renew a display of said table and a plurality of HTML (HyperText Markup Language) codes that substantially reflect said table in accordance with said table structures on said display device.

10. The apparatus of claim 9 further comprising:
a portion configured to receive a second indication that said user wants to modify a layout of said table in accordance with said display elements;
a portion configured to change said table structures according to said modified layout; and
a portion configured to generate in response to said second indication to change said display of said table and changing said HTML codes.

11. The apparatus of claim 9 further comprising a portion configured to generate a plurality of XML (extensible Markup Language) codes.

12. The apparatus of claim 9, wherein said display elements comprise a plurality of object types selected from the groups of text, image, video, flash, and Java applet.

13. A computer usable medium having a plurality of computer readable codes embodied therein for allowing a user to edit a table of a Web page, said computer readable codes able to:
display said table and a plurality of display elements on a display device, said table having a plurality of cells;
receive a first indication that said user wants to add at least one of said display elements to one of said cells of said table;
add a cell structure for said display element to a plurality of table structures, said table structures corresponding to said table on said display device; and
generate in response to said first indication to change a display of said table and a plurality of HTML (HyperText Markup Language) codes that substantially reflect said table in accordance with said table structures on said display device.

14. The computer usable medium of claim 13, wherein said computer readable codes are further able to:
receive a second indication that said user wants to modify a layout of said table in accordance with said display elements;
change said table structures according to said modified layout; and
generate in response to said second indication to change said display of said table and change said HTML codes.

15. The computer usable medium of claim 13, wherein said computer readable codes are further able to generate a plurality of XML (extensible Markup Language) codes.

16. The computer usable medium of claim 13, wherein said display elements comprise a plurality of object types selected from the groups of text, image, video, flash, and Java applet.
